(19) United States
(12) Patent Application Publication
(10) Pub. No.: US 2015/0321957 A1
(43) Pub. Date: Nov. 12, 2015

(54) ADDITIVE FOR HYDRAULICALLY SETTING MIXTURES

(71) Applicant: DOW GLOBAL TECHNOLOGIES LLC, Midland, MI (US)

(72) Inventors: Wolfgang DANNHORN, Soltau (DE); Grit GROTE, Soltau (DE); Rene KIESEWETTER, Wietzendorf (DE); Matthias KNARR, Nienburg/Weser (DE)

(21) Appl. No.: 14/651,858

(22) PCT Filed: Dec. 11, 2013
(86) PCT No.: PCT/US2013/074255

§ 371 Date: Jun. 12, 2015

Related U.S. Application Data
(60) Provisional application No. 61/737,171, filed on Dec. 14, 2012.

(51) Int. Cl. C04B 24/38; C04B 24/16

(52) U.S. Cl. CPC C04B 24/386; C04B 24/16

(57) ABSTRACT

The present invention relates to a hydraulic binder-free composition comprising a water soluble polysaccharide-derived water retention agent for use in the preparation of dry mortar formulations, in particular, cement based tile adhesives (CBTA), adhesive, ETICS base coat or adhesive formulations and/or grouts. The invention further relates to a dry mortar formulation comprising said a hydraulic binder-free composition. Furthermore, the invention is directed to the use of such a hydraulic binder-free compositions for increasing, once cured, the adhesive, flexural and/or compressive strength of a dry mortar formulation.

The present invention relates to hydraulic setting mixtures with improved mechanical properties. In particular, the present invention relates to a composition which, when incorporated within a hydraulic setting mixture, provides an increase in adhesive, flexural and/or compressive strength. Also provided is a process for producing such compositions, a dry mortar formulation comprising a hydraulic binder and such a composition, a hydraulic setting mixture comprising such a dry mortar formulation and water, and a method of modifying a conventional hydraulic binder-containing dry mortar formulation. Further, the use of such a composition to increase, once cured, the adhesive, flexural and/or compressive strength of a dry mortar formulation comprising hydraulic binder is also provided.

### BACKGROUND

Hydraulic setting mixtures are widely used in the construction industry. For example, they can be used as adhesive compositions, in particular tile adhesive compositions, which strongly hold two surfaces together once the setting process has completed. Other applications of such hydraulic setting mixtures include concrete (a mixture comprising cement, sand and stone which, upon combination with water, solidifies and hardens), cementitious adhesives or reinforcement coats for exterior insulation finishing systems (EIFS) and/or External Thermal Insulation Composite Systems (ETICS), grouts and self-levelling underlays (SLUs).

Hydraulic setting mixtures are generally prepared at the point of use by combining hydraulic mortars, i.e. dry mixtures typically comprising not less than 5 weight percent hydraulic binder, based on the total dry weight of the mortar, with an amount of water sufficient to enable the application of the resultant cement composition to a surface prior to it setting and hardening upon drying.

Conventional hydraulic compositions often comprise a combination of hydraulic binder, e.g. cement, and one or more additives, such as sand, lime, dispersants, thickeners and plasticizers, which provide a modified hydraulic composition with improved physical characteristics. In particular, the use of fine aggregate materials such as silica sand is well known. Further, water retention agents may be utilized to impart a beneficial effect upon the physical characteristics of the hydraulic composition and/or the resultant hardened product, which are highly dependent upon both the initial hydration process and the subsequent water removal as the composition sets and hardens upon drying. For example, the incorporation of water retention additives may lead to increase in open time, setting rate and drying time.

WO-A-2011087262 discloses an additive composition for a skim coat mortar, wherein said composition comprises a cellulose ether and an ionic surfactant selected from sulfonates, sulfates, esters and amino acids.

U.S. Pat. No. 7,985,293 discloses a hydraulic composition with improved workability in coating with a trowel. The hydraulic composition comprises at least one foaming anionic surfactant, at least one non-foaming non-ionic surfactant and a water soluble cellulose ether.

KR-A-2010068808 discloses a cement additive which, when included in a cement composition provides improved workability and working time and a reduction in efflorescence. The cement additive comprises a cellulose ether, a surfactant and a retarder. The surfactant comprises a mixture of anionic (such as sulfonates, sulfates, esters, amino acids and soaps) and non-ionic (such as ethoxylated compounds, alkanolamides, esters of polyhydroxy compounds, amine oxides and ethyleneoxide-propyleneoxide block polymers).

Conventional hydraulic setting compositions such as those described above can, by the incorporation of a retarding agent, achieve a long open time. However, use of such retarders also leads to a significant delay in hydraulic setting kinetics. Such impact on setting brings economic drawbacks as a result of delays in the construction progress. Further, other disadvantages associated with such conventional compositions include low adhesion strength upon setting of the hydraulic setting composition. Accordingly, there remains a desire to increase the adhesion strength of hydraulic setting compositions

It has been surprisingly found that a specific type of surfactant, when added in a small amount to a standard dry mortar formulation, results in an increase in the adhesive, flexural and/or compressive strength following curing of the dry mortar formulation. Further, it has been shown that such small amounts of this surfactant can be effectively incorporated into conventional dry mortar formulations via combination with a conventional water soluble polysaccharide-derived water retention agent prior to combination of the resultant mixture with a standard dry mortar formulation.

### Statement of the Invention

The present invention in its various aspects is as set out in the accompanying claims.

According to a first aspect, the present invention provides a hydraulic binder-free composition for use as a modifying additive in a hydraulic setting mixture, said composition comprising: one or more water soluble polysaccharide-derived water retention agents; and one or more surfactants according to Formula I

MSO₃—R¹—(—COOR²)ₙ (Formula I)

wherein M represents a hydrogen, metal or ammonium cation; R¹ represents a linear or branched, saturated or unsaturated C₁₋₁₀ alkylene moiety which is optionally substituted with one or more hydroxyl, halogen, nitro and/or cyano groups; each R² independently represents a linear or branched, saturated or unsaturated C₁₋₂₂ alkyl radical or a hydrogen, metal or ammonium cation; and n represents an integer from 1 to 10; wherein the weight ratio of said water retention agent(s) to said surfactant(s) is from 1:1 to 199:1.

According to a second aspect, the present invention provides a process for producing the composition of the first aspect of the present invention, said process comprising: a) providing a liquid or solid composition comprising one or more water soluble polysaccharide-derived water retention agents; b) providing a liquid composition comprising one or more surfactants according to Formula I

MSO₃—R¹—(—COOR²)ₙ (Formula I)

wherein M represents a hydrogen, metal or ammonium cation; R¹ represents a linear or branched, saturated or unsaturated C₁₋₁₀ alkylene moiety which is optionally substituted with one or more hydroxyl, halogen, nitro and/or cyano groups; each R² independently represents a linear or branched, saturated or unsaturated C₁₋₂₂ alkyl radical or a hydrogen, metal or ammonium cation; and n represents an integer from 1 to 10; c) preparing a water retention agent-surfactant mixture by combining an amount of the composition of step a) with an amount of the composition of step b) such that the weight ratio of said water retention agent(s) to said surfactant(s) is from 1:1 to 199:1; and d) drying said water retention agent-surfactant mixture.

According to a third aspect, the present invention provides a modified dry mortar formulation which may be combined with water to form a hydraulic setting mixture, wherein said modified dry mortar comprises: a) a standard dry mortar formulation comprising hydraulic binder; and b) from 0.1 to 2.5%), based on the total dry weight of the modified dry mortar formulation, of the hydraulic binder free-composition according to the first aspect of the present invention, wherein said modified dry mortar formulation comprises no more than 1%, based on the total dry weight of the modified dry mortar formulation, of surfactants according to Formula (I) as defined above.

According to a fourth aspect, the present invention provides a hydraulic setting mixture comprising the dry mortar formulation of the third aspect of the present invention and water.

According to a fifth aspect, the present invention provides a method for modifying a dry mortar formulation, said method comprising: a) providing a standard dry mortar formulation comprising hydraulic binder; b) providing a composition according to the first aspect of the present invention; and c) combining the composition of step b) with the formulation of step a) to provide a modified dry mortar comprising from 0.1 to 2.5%, based on the total weight of the modified dry mortar formulation, of the composition according to the first aspect of the present invention, provided that the resultant modified dry mortar formulation comprises no more than 1%, based on the total dry weight of the modified dry mortar formulation, of surfactants according to Formula 1 as defined above.

According to a sixth aspect, the present invention provides use of the composition of the first aspect of the present invention as a modifier composition for a hydraulic binder-containing dry mortar formulation or a hydraulic setting mixture comprising such a dry mortar formulation.

According to a seventh aspect, the present invention provides use of the composition of the first aspect of the present invention to increase, once cured, the adhesive, flexural and/or compressive strength of a dry mortar formulation comprising hydraulic binder.

Hydraulic setting mixtures prepared according to the present invention demonstrate an increase in adhesive, flexural and/or compressive strength following curing of the dry mortar formulation.

### DETAILED DESCRIPTION OF THE INVENTION

Throughout the specification, any reference to “percent” or “percent weight” is expressed in terms of dry weight of the composition, formulation or mixture unless otherwise specified.

“EN” stands for European Norm and designates a test method as a prefix to the test method number. The test method is the most current test method as of the priority date of this application.

As used herein, the term “hydraulic setting mixture” means a composition used in the construction field comprising a hydraulic binder, filler(s), water retention agent(s), and, optionally, polymer containing additives such as a polymer dispersion and/or a redispersible polymer powder.

As used herein, the term “water soluble” refers to any compound which is soluble in water at 20° C.

As used herein, the term “hydraulic binder” refers to a mineral composition, normally of finely ground materials, which upon addition of an appropriate quantity of water forms a binding paste or slurry capable of hardening of hydration in air as well as under water and binds together the granulates.

The hydraulic binder-free composition of the present invention comprises one or more surfactants according to Formula I

MSO₃—R¹—(—COOR)ₙ Formula (I)

wherein M represents a hydrogen, metal or ammonium cation, preferably a metal cation, more preferably sodium; R¹ represents a linear or branched, saturated or unsaturated C₁₋₁₀, preferably a C₂₋₄, alkylene moiety, which is optionally substituted with one or more hydroxyl, halogen, nitro and/or cyano groups; each R² independently represents a linear or branched, saturated or unsaturated C₁₋₂₂, preferably C₂₋₈, alkyl radical or a hydrogen, metal or ammonium cation; and n represents an integer from 1 to 10, preferably an integer from 1 to 5.

More preferably, in Formula I n represents 2 and, still more preferably, the surfactant is a compound according to Formula (II) or Formula (III)

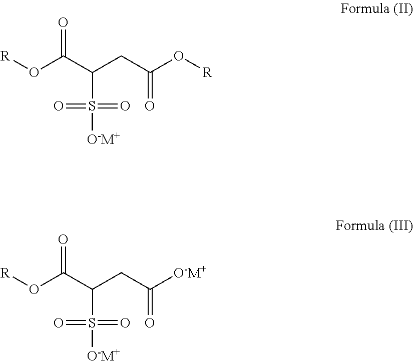

Still more preferably, the surfactant is selected from a dioctyl sulfosuccinate salt, a dihexyl sulfosuccinate salt and combinations thereof. Still more preferably, the surfactant is a dioctyl sulfosuccinate salt, most preferably sodium dioctyl sulfosuccinate, i.e. sodium 1,4-bis(2-ethylhexoxy)-1,4-dioxobutane-2-sulfonate.

The hydraulic binder-free composition of the present invention also comprises one or more water soluble polysaccharide-derived water retention agents. Preferably, the water retention agent is selected from water soluble cellulose ethers, starch ethers, bacterial capsular polysaccharides (which include xanthan gum, dextran, welan gum, gellan gum, diutan gum and pullulan), other naturally occurring polysaccharides such as alginates and carrageenan, and mixtures thereof. More preferably, the water retention agent is a water soluble cellulose ether.

Preferably, the cellulose ether suitable for use in the present invention are selected from the group consisting of hydroxyalkylcelluloses (e.g., hydroxyethylcellulose (HEC), hydroxypropylcellulose (HPC) and hydroxypropylhydroxyethylcellulose (HPHEC)), carboxy-alkylcelluloses (e.g., carboxymethylcellulose (CMC)), carboxyalkylhydroxyalkylcelluloses (e.g., carboxymethylhydroxyethylcellulose (CMHEC) and carboxymethyl-hydroxypropylcellulose (CMHPC)), sulphoalkylcelluloses (e.g., sulphoethylcellulose (SEC) and sulphopropylcellulose (SPC)), carboxyalkylsulphoalkylcelluloses (e.g., carboxymethylsulphoethylcellulose (CMSEC) and carboxymethylsulphopropylcellulose (CMSPC)), hydroxyalkylsulphoalkylcelluloses (e.g., hydroxyethylsulphoethyl cellulose (HESEC), hydroxypropylsulphoethylcellulose (HPSEC) and hydroxyethylhydroxypropylsulphoethyl cellulose (HEHPSEC)), alkylhydroxyalkylsulphoalkyl celluloses (e.g., methylhydroxyethylsulphoethyl cellulose (MHESEC), methylhydroxypropylsulphoethylcellulose (MHPSEC) and methylhydroxyethylhydroxypropylsulphoethylcellulose (MHEHPSEC)), alkylcelluloses (e.g., methylcellulose (MC) and ethylcellulose (EC)), binary or ternary alkylhydroxyalkylcellulose (e.g., hydroxyethylmethylcellulose (HEMC), ethylhydroxyethylcellulose (EHEC), hydroxypropylmethylcellulose (HPMC), ethylhydroxypropylcellulose (EHPC), ethylmethylhydroxyethylcellulose (EMHEC), and ethylmethylhydroxypropylcellulose (EMHPC)), alkenylcelluloses and ionic and nonionic alkenylcellulose mixed ethers (e.g., allylcellulose, allylmethylcellulose, allylethylcellulose and carboxy-methylallylcellulose)), dialkylaminoalkylcelluloses (e.g., N,N-dimethylaminoethylcellulose and N,N-diethylaminoethylcellulose), dialkylaminoalkylhydroxyalkylcelluloses (e.g., N,N-dimethylaminoethylhydroxyethyl cellulose and N,N-dimethylaminoethylhydroxypropylcellulose), aryl-, arylalkyl- and arylhydroxyalkylcelluloses (e.g., benzylcellulose, methylbenzylcellulose and benzylhydroxyethylcellulose), as well as salts thereof (e.g., sodium carboxymethyl cellulose ether) and reaction products of the above-stated cellulose ethers with hydrophobically modified glycidyl ethers, which have alkyl residues with C₃ to C₁₅ carbon atoms or arylalkyl residues with C₇ to C₁₅ carbon atoms. More preferably, the cellulose ether is a binary or ternary alkylhydroxyalkylcellulose. Still more preferably, the cellulose ether is selected from hydroxyethylmethylcellulose (HEMC) and hydroxypropylmethylcellulose (HPMC).

In the hydraulic binder-free composition of the present invention, the weight ratio of said water retention agent(s) to said surfactant(s) is from 1:1 to 199:1. Within this range, the maximum amount of said water retention agent(s) relative to said surfactant(s) is preferably 497:3, more preferably 993:7, still more preferably 124:1, and most preferably 991:9. At the same time, the minimum amount of water retention agent(s) relative to said surfactant(s) is preferably 3:2, more preferably 7:3, still more preferably 4:1, and most preferably 9:1.

The hydraulic binder-free compositions may further comprise additional components. For example, for applications in which the hydraulic mixture should have good workability (e.g. tile adhesives), the hydraulic binder-free composition preferably includes one or more stabilizers selected from lime, air entraining agents (the presence of which lead to air filled voids in hydraulic mixtures), coalescents, superplasticizers, rheological modifiers and mixtures thereof. In particularly preferred embodiments, the stabilizer is an air entraining agent. Preferably, the air entraining agent is an alkylpolyglucoside (APG), fattyalcoholsulfate, fattyalcoholethersulfate, alkylpolyglycolether, fattyalcoholethoxylate or combinations thereof. More preferably, the stabilizer is a fattyalcoholethersulfate such as sodium lauryl sulphate (available commercially as a powder with 99% active content from BASF, Germany as Loxanol™ K 12 P. In embodiments in which the hydraulic binder-free composition includes such a stabilizer, it is preferred that the weight ratio of said water retention agent(s) to said stabilizer(s) is from 19:1 to 999:1, preferably from 9:1 to 499:1

According to the second aspect, the hydraulic binder-free compositions are prepared by a process in which a liquid or solid composition comprising said water retention agent(s) is combined with a liquid composition comprising one or more surfactants according to Formula 1 to provide a water retention agent-surfactant mixture in which the weight ratio of said water retention agent(s) to said surfactant(s) is from 1:1 to 199:1. Preferably, the maximum amount of said water retention agent(s) relative to said surfactant(s) is 497:3, more preferably 993:7, still more preferably 124:1, and most preferably 991:9. At the same time, the minimum amount of water retention agent(s) relative to said surfactant(s) is preferably 3:2, more preferably 7:3, still more preferably 4:1, and most preferably 9:1.

Preferably, the hydraulic binder-free compositions are prepared by a process comprising:
(1) washing the solid water retention agents(s) in hot water before filtering to form a wet filter cake;
(2) spraying an aqueous solution comprising the surfactant according to Formula I onto the wet filter cake whilst homogenously mixing the filter cake, e.g. in a kneader, to form granulates; and
(3) drying and milling the granules obtained in step (2) above to form a powder.

According to a third aspect, the present invention provides a modified dry mortar formulation which may be combined with water to form a hydraulic setting mixture, wherein the hydraulic mortar comprises a standard dry mortar formulation comprising one or more hydraulic binders and from 0.1 to 2.5%, based on the total dry weight of the modified dry mortar formulation, of a hydraulic binder-free composition of the first aspect of the present invention. Preferably, the composition of the first aspect is present in an amount of at least 0.2%, and more preferably in an amount of at least at least 0.3%. At the same time, it is preferred that the modified dry mortar comprises no more than 1.0%, and more preferably no more than 0.8% of the composition of the first aspect.

Although any conventional hydraulic binder may be used in such dry mortars, it is preferred that the hydraulic binder is cement. More preferably, the hydraulic binder is Portland cement, in particular, the types of CEM I, II, III, IV and V, and/or alumina cement (aluminate cement) and combinations thereof. Preferably, the mortar comprises hydraulic binder in an amount not less than 10 weight percent, more preferably not less than 20 weight percent, and even more preferably not less than 30 weight percent. At the same time, it is preferred that the mortar comprises no more than 60 weight percent, more preferably no more than 50 weight percent and even more preferably no more than 40 weight percent hydraulic binder.

The modified dry mortar formulations comprise no more than 1%, preferably no more than 0.9%, even more preferably no more than 0.8%, based on the total dry weight of the formulation, of surfactant(s) according to Formula I because it is believed that, at concentrations above this level, the observed improvement in adhesive, flexural and/or compressive strength is reduced or even lost. Furthermore, the addition of such surfactants in amounts above this level may have a significant detrimental effect upon the setting kinetics of the dry mortar formulations upon combination with water to such an extent that the final composition will not set to a satisfactory standard or within an acceptable timescale. Indeed in order to reduce and/or eliminate any potential detrimental effect upon the setting kinetics of the hydraulic compositions, it is preferred that the dry mortar formulation comprises the hydraulic binder-free composition in an amount such that the dry mortar formulation comprises no more than 0.5%, more preferably no more than 0.1%, based on the total dry weight of the formulation, of surfactant(s) according to Formula I. At the same time it is preferred that the dry mortar formulations comprise at least 0.0001%, more preferably at least 0.001%, based on the total dry weight of the formulation, of surfactant(s) according to Formula I.

Although the amount used will vary depending upon intended use, it is preferred that the dry mortar formulation comprises the hydraulic binder-free composition in an amount sufficient that the formulation contains from 0.1 to 1.2%, more preferably from 0.2 to 1.0% weight percent, based on the total weight of the dry mortar, of the water soluble polysaccharide-derived water retention agent. The incorporation of such water-retention agent(s) is conventional in the art and is known to impart a beneficial effect upon the physical characteristics of hydraulic compositions. For example, by incorporating such water retention additives the skilled artisan may modify properties such as open time, setting rate and drying time of the resultant hydraulic composition. By incorporating the hydraulic binder-free composition in such an amount within a dry mortar formulation, the requirement for additional conventional water retention additives may be reduced or eliminated.

Preferably, the dry mortar further comprises one or more fillers. In such embodiments, it is preferred that the fillers are aggregate materials having a particle size of no more than 1.0 mm Preferably, the aggregate materials are selected from silica sand, dolomite, limestone, perlite, expanded polystyrene, hollow glass spheres, rubber crumbs, fly ash and combinations thereof. More preferably, the aggregate material is a silica sand. In embodiments in which one or more fillers are included within the hydraulic mortar, it is preferred that the mortar comprises at least 1 weight percent, more preferably at least 20 weight percent, and still more preferably at least 40 weight percent of such material. At the same time, it is preferred that the mortar comprises no more than 85 weight percent, more preferably no more than 70 weight percent and most preferably no more than 65 weight percent of such material.

Preferably, the hydraulic mortar further comprises one or more redispersible polymer powder (RDP) binder. A wide variety of RDPs, which may be made by spray drying an emulsion polymer in the presence of various additives such as a protective colloid and anti-caking agent, are well known in the art and are available from commercial sources, and all of which are believed to be suitable for use in the present invention. Preferably, such RDPs are homopolymers, copolymers or terpolymers of one or more monomers selected from the group consisting of styrene, butadiene, vinyl acetate, versatate, propionate, laurate, vinyl chloride, vinylidene chloride, ethylene, and acrylates, e.g., ethylene/vinylacetate copolymer (vinyl ester-ethylene copolymer), vinylacetate/vinyl-versatate copolymer, and styrene/acrylic copolymer. More preferably, the RDP is a copolymer based on vinyl acetate-ethylene, such as DLP 2000 (available from Dow Wolff Cellulosics, Germany). When mixed with water, the RDPs can be re-dispersed to form an emulsion, which in turn forms continuous films within a hydraulic setting mixture when the water is removed by evaporation and hydration of the hydraulic binder.

The use of such RDP binders is not mandatory, but optional. EN12004 and EN12002 give performance standards regarding a hydraulic setting adhesive containing a polymeric binder. When such polymeric binders are present, the hydraulic mortar preferably comprises at least 0.3% weight percent, preferably at least 0.5% weight percent, and more preferably at least 1.5 weight percent polymeric binder, based on the total dry weight of the hydraulic mortar. At the same time, it is preferred that the mortar comprises no more than 50 weight percent, more preferably no more than 10 weight percent and even more preferably no more than 5 weight percent polymeric binder(s).

The hydraulic mortar optionally contains further additives selected from organic or inorganic thickening agents and/or secondary water retention agents, anti-sag agents, air entraining agents/coalescents, wetting agents, defoamers, superplasticizers, dispersants, calcium complexing agents, retarders, accelerators, water repellents, biopolymers and fibres, all of which are well known in the art and are available from commercial sources. Preferably, when included in the hydraulic mortars, such additives are present in amounts from 0.001 to 5 weight percent, based on the total dry weight of the hydraulic mortar.

According to a Fourth aspect, the present invention provides a hydraulic setting mixture comprising a hydraulic mortar according to the third aspect of the present invention and water. The hydraulic setting mixture can be prepared according to conventional methods, such as those of EN1346 and EN1348. Preferably, the dry ingredients such as the hydraulic mortar and the composition of the first aspect of the present invention are homogenously mixed before any liquid ingredients such as water and, if required, a liquid binder such as a polymer dispersion are added.

A polymer dispersion is a two phase system comprising finely dispersed polymeric particles in solvent, such as water. The polymer dispersion normally comprises polymeric particles as a polymeric binder, such as vinyl polymer or polyacrylic ester copolymer, and a surfactant containing hydrophobic and hydrophilic moieties. The finely dispersed polymer particles will coalesce and form a polymer film upon the evaporation of water.

According to a fifth aspect, a method for modifying a dry mortar formulation is provided. This method comprises: providing a standard dry mortar formulation comprising a hydraulic binder; providing a composition according to the first aspect of the invention; and combining the composition of the first aspect of the present invention with the standard dry mortar formulation to provide a modified dry mortar formulation comprising from 0.1 to 2.5%, based on the total dry weight of the modified hydraulic mortar formulation, of the composition of the first aspect of the present invention, provided that the resultant modified dry mortar formulation comprises no more than 1%, based on the total dry weight of the modified dry mortar formulation, of surfactants according to Formula 1 as described above. Preferably, the dry mortar formulation comprises at least 0.2%, more preferably at least 0.3% of the composition of the first aspect. At the same time, it is preferred that the modified dry mortar comprises no more than 1.0%, and more preferably no more than 0.8% of the composition of the first aspect of the invention. It is also preferred that the composition of the first aspect of the invention should be combined with the standard dry mortar formulation comprising hydraulic binder in an amount such that the modified dry mortar formulation will comprise no more 0.9%, even more preferably no more than 0.8%, based on the total dry weight of the formulation, of surfactant(s) according to Formula. Further, to reduce and/or eliminate any potential detrimental effect upon the setting kinetics of the hydraulic compositions, it is preferred that the dry mortar formulation comprises the hydraulic binder-free composition in an amount such that the dry mortar formulation comprises no more than 0.5%, more preferably no more than 0.1%, based on the total dry weight of the formulation, of surfactant(s) according to Formula I. At the same time it is preferred that the dry mortar formulations comprise at least 0.0001%, more preferably at least 0.001%, based on the total dry weight of the formulation, of surfactant(s) according to Formula I.

According to a sixth and seventh aspect respectively, the composition of the first aspect is used i) as a modifier composition for a hydraulic binder-containing dry mortar formulation or a hydraulic setting mixture comprising such a dry mortar formulation; and ii) for increasing, once cured, the adhesive, flexural and/or compressive strength of a dry mortar formulation comprising hydraulic binder. In each of these aspects, the composition of the first aspect of the invention should be combined with a standard dry mortar formulation comprising hydraulic binder in an amount such that the modified dry mortar formulation will comprise no more than 1%, preferably no more than 0.9%, even more preferably no more than 0.8%, based on the total dry weight of the formulation, of surfactant(s) according to Formula I. To reduce and/or eliminate any potential detrimental effect upon the setting kinetics of the hydraulic compositions, it is preferred that the dry mortar formulation comprises the hydraulic binder-free composition in an amount such that the dry mortar formulation comprises no more than 0.5%, more preferably no more than 0.1%, and still more preferably no more than 0.05%, based on the total dry weight of the formulation, of surfactant(s) according to Formula I. At the same time it is preferred that the dry mortar formulations comprise at least 0.00001%, more preferably at least 0.0001% and still more preferably at least 0.001%, based on the total dry weight of the formulation, of surfactant(s) according to Formula I.

It is believed that the hydraulic binder free composition of the first aspect of the present invention may be advantageously incorporated into any dry mortar formulation comprising a hydraulic binder. However, according to a first preferred aspect of the invention, the dry mortar formulation is a grout formulation. In a second, equally preferred aspect, the dry mortar formulation is a cement based tile adhesive formulation. In a third, equally preferred aspect, the dry mortar formulation is a cementitious adhesive or coating formulation for exterior insulation finishing systems (EIFS) and/or External Thermal Insulation Composite Systems (ETICS).

Some embodiments of the invention shall now be further described by way of exemplification only. All ratios, parts and percentages are expressed by dry weight unless otherwise specified, and all components are of good commercial quality unless otherwise specified.

### EXAMPLES

The performance of cementitious dry mix formulations according to the present invention has been studied by comparing cement based tile adhesive (CBTA), tile grout and ETICS base coat adhesive/reinforcement coats formulations in the presence and absence of various surfactant compounds. Further, the suitability of water retention agents as vehicles by which small amounts of surfactant compounds may be incorporated into dry mix formulations was examined by monitoring the performance of dry mix formulations with and without substituting a portion of the water retention agent, i.e. a water-soluble cellulose ether, with such surfactants.

Cement Composition Preparation

Throughout the examples, the required quantity of each cement composition was prepared by combining a measured amount of the homogenous dry mortar with a measured amount of

$$( “ \frac{W}{S} ” )$$

water and mixing by hand. In each case, the water-solids-factor was calculated as follows:

$$\frac{W}{S} = \frac{initial quantity of water ( g )}{quantity of modified dry mortar ( g )}$$

Evaluation of Setting Time

The overall setting time of various cement compositions were determined using an automated Penetrometer (Dettki AVM-14-PNS), supplied by Dettki Messautomatisierung, 78736 Epfendorf/Germany. At the commencement of each test, cement compositions were prepared by pouring the required amount of water into a mixing vessel before gradually adding 400 g of the homogenous dry mortar and stirring by hand for 1 minute. Upon completion of the mixing process, the cement composition was then transferred into a polystyrene cup having an internal diameter of 93 mm and a height of 38 mm, taking care to avoid entrapping air within the composition, and the filled cup is then placed on a vibrating table to compress the mixture. Once the mixture has been subjected to 15 cycles of the compressive force, a smooth horizontal surface is then prepared in the cement composition by scraping away any excess cement composition using a spatula in a sawing motion. A border comprising 5 mm deep layer of cement composition is then applied to the outer circumference of the smoothed surface to provide a liquid tight seal, and a layer of liquid paraffin is placed above the smooth cement composition surface to suppress skin formation and prevent the cement composition from sticking to the testing needle during analysis. The samples are then placed into the penetrometer for automated analysis, with setting times being calculated from a notional start point at which mixing was initiated. During the testing procedure, the time at which needle penetration is limited to a depth 36 mm is recorded as the setting “start” time with the time at which the needle penetration is limited to a depth of 2 mm being recorded as the setting “end” time. By simple subtraction of the recorded start value from the recorded end value, a setting duration is calculated.

### Example 1

### Cellulose Ether Compositions

Cellulose ether compositions were prepared comprising a conventional cellulose ether, i.e. Walocel™ MTW 8000 PF 10 (Dow Wolff Cellulosics, Germany) and an additive identified in Table 1, wherein the weight ratio of cellulose ether to additive (active component) was 99:1. Each of Examples 1.1 to 1.15 were prepared by a process wherein the cellulose ether was washed in water before filtering to form a wet filter cake to which an aqueous solution comprising the desired additive was sprayed whilst subjecting to the filter cake to homogenous mixing in a kneader to from granulates. The granulates were then dried and milled in a conventional manner to form each cellulose ether composition.

TABLE 1

| Example | Cellulose ether (wt. %) | Additive (wt. %) |
|---|---|---|
| 1.1 | Walocel (99 wt. %) | Sulfosuccinic acid¹ (1 wt. %) |
| 1.2 | Walocel (99 wt. %) | Sodium dioctyl sulfosuccinate²(1 wt. %) |
| 1.3 | Walocel (99 wt. %) | Sodium dihexyl sulfosuccinate³ (1 wt. %) |
| 1.4 | Walocel (99 wt. %) | Dioctyl sulfosuccinate⁴ (1 wt. %) |
| 1.5 | Walocel (99 wt. %) | Sulfosuccinatemonoester⁵ (1 wt. %) |
| 1.6 | Walocel (99 wt. %) | Sodium diisobutyl sulfosuccinate⁶ (1 wt. %) |
| 1.7 | Walocel (99 wt. %) | Sulfosuccinate monoester⁷ (1 wt. %) |
| 1.8 | Walocel (99 wt. %) | Docusate sodium⁸ (1 wt. %) |
| 1.9 | Walocel (99 wt. %) | Sodium diamyl sulfosuccinate⁹ (1 wt. %) |
| 1.10 | Walocel (99 wt. %) | 2-ethyl-l-hexanol¹⁰ (1 wt. %) |
| 1.11 | Walocel (99 wt. %) | Dioctyl sulfosuccinate¹¹ (1 wt. %) |
| 1.12 | Walocel (99 wt. %) | Dioctyl sulfosuccinate¹² (1 wt. %) |
| 1.13 | Walocel (99 wt. %) | Dioctyl sulfosuccinate¹⁴ (1 wt. %) |
| 1.14 | Walocel (99 wt. %) | Sodium dioctyl sulfosuccinate/sodium benzoate¹⁵ (1 wt. %) |
| 1.15 | Walocel (99 wt. %) | Sodium dicyclohexyl sulfosuccinate¹⁶ (1 wt. %) |

¹70 wt. % solution in water from Sigma Aldrich, Germany;
²100% waxy solid supplied by Intatrade, Germany;
³~80 wt. % solution in water from Sigma Aldrich, Germany;
⁴liquid composition commercially available from Cytec Industries USA as Aerosol ™ OT-85 AE;
⁵liquid composition commercially available from Cytec Industries USA as Aerosol ™ EF-810;
⁶liquid composition commercially available from Cytec Industries USA as Aerosol ™ IB-45;
⁷liquid composition commercially available from Cytec Industries USA as Aerosol ™ EF-800;
⁸sodium dioctyl sulfosuccinate supplied in wax form from Cytec Industies USA as Aerosol ™ OT-100;
⁹wax composition available from Cytec Industries USA as Aerosol ™ AY;
¹⁰>99% solution in water from Sigma Aldrich, Germany;
¹¹~65 wt. % dispersion in water commercially available from Elementis Specialities, USA as Serwet ™ 170;
¹²dispersion in water commercially available from Elementis Specialities, USA as Serwet ™ 175;
¹³aqueous solution containing 10% EtOH commercially available from Akzo Nobel, USA as Lankropol ™ 4500;
¹⁴blend of sodium dioctyl sulfosuccinate and sodium benzoate commercially available in in powdered form by Cytec Industries USA as Aerosol OTB-B;
¹⁵liquid composition commercially available from Cytec Industries USA as Aerosol A-196-97

### Example 2

### Cement Based Tile Adhesive (CBTA)

The performance of CBTA compositions according to the invention was studied by comparing various formulations comprising the cellulose ether compositions of Example 1. In each test, a CBTA formulation was prepared comprising: 35.0 wt. % Ordinary Portland Cement CEM I 52.5 R (Milke, Germany); 31.05 wt. % Quartz sand F32 (Quarzwerke Frechen, Germany); 31.05 wt. % Quartz sand F36 (Quarzwerke Frechen, Germany), 2.5 wt. % of an vinyl acetate-ethylene polymer RDP, i.e. DLP2000™ (Dow Chemical Company); and 0.4 wt. % of a cellulose ether composition according to example 1.

As shown in Tables 2 and 2A, below, the water-solid factor (w/s), setting time, tensile adhesive strength (measured according to EN 1348), setting time and open time (measured according to EN 1346) were recorded for CBTA compositions comprising each of the cellulose ether compositions of Example 1.1 to 1.15.

TABLE 2

| Example | 2.1 | 2.2 | 2.3 | 2.4 | 2.5 | 2.6 | 2.7 | 2.8 | 2.9 |
|---|---|---|---|---|---|---|---|---|---|
| Cellulose Ether | 1.1 | 1.2 | 1.3 | 1.4 | 1.5 | 1.6 | 1.7 | 1.8 | 1.9 |
| W | 0.275 | 0.275 | 0.275 | 0.275 | 0.275 | 0.275 | 0.275 | 0.275 | 0.275 |
| S | | | | | | | | | |
| Setting Time: | | | | | | | | | |
| Initial (min) | 817 | 758 | 820 | 759 | 824 | 789 | 796 | 744 | 823 |
| Final (min) | 863 | 876 | 952 | 956 | 952 | 902 | 848 | 857 | 900 |
| Total (min) | 46 | 118 | 132 | 197 | 128 | 113 | 52 | 113 | 77 |
| Adhesive Strength: | | | | | | | | | |
| (N/mm²) | | | | | | | | | |
| Normal climate | 1.15 | 1.35 | 0.99 | 1.53 | 1.17 | 1.15 | 0.95 | 1.29 | 1.00 |
| Water immersion | 0.86 | 0.99 | 0.73 | 1.05 | 0.86 | 0.86 | 0.72 | 1.06 | 0.83 |
| Heat Storage | 1.05 | 1.06 | 0.81 | 0.96 | 0.86 | 0.91 | 0.73 | 0.97 | 0.87 |
| Open time (N/mm²): | | | | | | | | | |
| 30 min | 0.64 | 0.83 | 0.73 | 0.73 | 0.74 | 0.79 | 0.60 | 0.82 | 0.93 |
| 40 min | 0.14 | 0.16 | 0.19 | 0.11 | 0.13 | 0.28 | 0.14 | 0.27 | 0.35 |

TABLE 2A

| Example | 2.10 | 2.11 | 2.12 | 2.13 | 2.14 | 2.15 |
|---|---|---|---|---|---|---|
| Cellulose | 1.10 | 1.12 | 1.13 | 1.14 | 1.15 | 1.16 |
| Ether | | | | | | |
| W | 0.275 | 0.275 | 0.275 | 0.275 | 0.275 | 0.275 |
| S | | | | | | |
| Setting Time: | | | | | | |
| Initial (min) | 827 | 768 | 769 | 763 | 733 | 746 |
| Final (min) | 905 | 868 | 859 | 827 | 916 | 898 |
| Total (min) | 78 | 100 | 90 | 64 | 183 | 152 |
| Adhesive | | | | | | |
| Strength: | | | | | | |
| (N/mm²) | | | | | | |
| Normal | 0.99 | 1.19 | 1.42 | 1.32 | 1.02 | 0.94 |
| climate | | | | | | |
| Water | 0.89 | 0.94 | 1.08 | 1.08 | 0.81 | 0.82 |
| immersion | | | | | | |
| Heat Storage | 0.94 | 1.07 | 1.07 | 1.13 | 0.95 | 0.85 |
| Open time | | | | | | |
| (N/mm²): | | | | | | |
| 30 min | 0.91 | 0.75 | 0.77 | 0.51 | 0.87 | 0.94 |
| 40 min | 0.31 | 0.16 | 0.06 | 0.07 | 0.28 | 0.37 |

The results clearly indicate that, by providing a composition comprising a water soluble polysaccharide-derived water retention agent, specifically a water soluble cellulose ether, and a surfactant of the present invention, an improvement in adhesive strength is observed upon combination of such a composition into CBTA formulations.

### Example 2

### Tile Grouts

To demonstrate that the benefit observed upon incorporation of surfactants according to Formula I as defined above is not limited to CBTA formulations, the performance of various tile grout formulations comprising a range surfactant compounds was analysed. For each test, a tile grout was prepared comprising: 30.0 wt. % Ordinary Portland Cement CEM I 42.5 R (Holcim, Germany); 2.0 wt. % high alumina cement (Secar™ 51, available from Kerneos, France); 15.0 wt. % Silica sand FH31 (Quarzwerke Frechen, Germany); 2 wt. % RDP (DLP2000); 10.0 wt. % calcium carbonate (Jura White™ CC902, Omya, Germany); 0.3 wt. %; superplasticizer (Melment™ F10, available from BASF, Germany); 0.1 wt. % hydroxyethylmethylcellulose ether, i.e. Walocel™ MTW 2000, available from Dow Wolff Cellulosics; and 0.05 to 0.8 wt. % of a surfactant as identified in Table 3 below; with the remainder of the formulation comprising F34 silica sand (Quarzwerke Frechen, Germany).

TABLE 3

| Example | Surfactant |
|---|---|
| 2.1 | 0.2 wt. % Sodium Oleate¹ |
| 2.2 | 0.05 wt. % sodium dioctyl sulfosuccinate² |
| 2.3 | 0.1 wt. % sodium dioctyl sulfosuccinate² |
| 2.4 | 0.2 wt. % sodium dioctyl sulfosuccinate² |
| 2.5 | 0.4 wt. % sodium dioctyl sulfosuccinate² |
| 2.6 | 0.8 wt. % sodium dioctyl sulfosuccinate² |
| 2.7 | 0.2 wt. % sodium diisobutyl sulfosuccinate³ |
| 2.8 | 0.2 wt. % sulfosuccinate monoester⁴ |
| 2.9 | 0.2 wt. % sodium dioctyl sulfosuccinate/sodium benzoate⁵ |
| 2.10 | 0.2 wt. % sodium dicyclohexyl sulfosuccinate⁶ |
| 2.11 | 0.2 wt. % succininc acid disodium salt⁷ |

¹97% powder supplied by Sigma-Aldrich, Germany;
²100% waxy solid supplied by Intatrade, Germany;
³liquid composition commercially available from Cytec Industries USA as Aerosol IB-45;
⁴liquid composition commercially available from Cytec Industries USA as Aerosol EF-810;
⁵blend of sodium dioctyl sulfosuccinate and sodium benzoate commercially available in in powdered form by Cytec Industries USA as Aerosol OTB-B;
⁶liquid composition commercially available from Cytec Industries USA as Aerosol A-196-97;
⁷>99% powder supplied by Sigma-Aldrich, Germany

As shown in Table 4 below, the water-solid factor

$$( \frac{W}{S} ) ,$$

flexural strength and compressive strength (each measured according to EN 12808-3), and setting time (measured according to CE 94.1) were recorded for the tile grout formulations of Examples 5.1 to 5.11. In addition, the workability of the formulations were visually inspected and allocated a workability rating of from 1 (excellent) to 5 (extremely poor).

TABLE 4

| | Example | | | | | | | | | | |
|---|---|---|---|---|---|---|---|---|---|---|---|
| | 2.1 | 2.2 | 2.3 | 2.4 | 2.5 | 2.6 | 2.7 | 2.8 | 2.9 | 2.10 | 2.11 |
| W | 0.17 | 0.17 | 0.17 | 0.17 | 0.17 | 0.17 | 0.17 | 0.17 | 0.17 | 0.17 | 0.17 |
| S | | | | | | | | | | | |
| Flexural Strength (N/mm²) | | | | | | | | | | | |
| 24 h | 1.9 | 3.9 | 3.9 | 4.2 | 3.9 | 2.9 | 2.4 | 2.4 | 3.3 | 2.9 | 2.4 |
| 7 d | 5.7 | 8.5 | 8.0 | 7.3 | 7.1 | 6.9 | 6.6 | 5.8 | 7.1 | 7.0 | 6.2 |
| 28 d | 7.4 | 9.9 | 9.7 | 11.3 | 10.8 | 10.7 | 8.8 | 8.1 | 10.5 | 9.3 | 7.7 |
| Compressive Strength (N/mm²) | | | | | | | | | | | |
| 24 h | 5.2 | 15.7 | 16.1 | 16.6 | 15.4 | 10.6 | 9.7 | 8.1 | 14.1 | 14.7 | 7.9 |
| 7 d | 11.4 | 20.8 | 21.8 | 20.0 | 20.0 | 18.7 | 15.3 | 12.7 | 19.1 | 18.1 | 13.5 |
| 28 d | 17.1 | 22.0 | 22.0 | 30.7 | 27.4 | 27.6 | 18.0 | 16.8 | 26.1 | 24.7 | 19.8 |
| Setting Time (min) | | | | | | | | | | | |
| Initial | 60 | 309 | 366 | 372 | 470 | 611 | 153 | 462 | 389 | 89 | 67 |
| Final | 83 | 340 | 378 | 382 | 520 | 747 | 260 | 540 | 459 | 110 | 89 |
| Total | 23 | 31 | 12 | 10 | 50 | 136 | 107 | 78 | 70 | 21 | 22 |
| Workability Rating | 2 | 3 | 3 | 3 | 3 | 3 | 2.5 | 1.5 | 4 | 1.5 | 2.0 |

These results indicate that mortar formulations comprising surfactants according to Formula I as defined above, in particular sodium dioctyl sulfosuccinate (DOSS), when present in an amount no more than 1 wt. %, based on the dry weight of the mortar composition, provides a surprising increase in mechanical strength (e.g. flexural, compressive and/or adhesive strength). Furthermore, although the addition of such surfactants may reduce the setting kinetics of the mortar compositions, by limiting the surfactant concentration to no more than 1 wt. %, acceptable setting times can be achieved.

1. A hydraulic binder-free composition for use as a modifying additive in a hydraulic setting mixture, said composition comprising:
a. one or more water soluble polysaccharide-derived water retention agents; and
b. one or more surfactants according to Formula I
MSO₃—R¹—(—COOR²)ₙ (Formula I)
wherein M represents a hydrogen, metal or ammonium cation; R¹ represents a linear or branched, saturated or unsaturated C₁₋₁₀ alkylene moiety which is optionally substituted with one or more hydroxyl, halogen, nitro and/or cyano groups; each R² independently represents a linear or branched, saturated or unsaturated C₁₋₂₂ alkyl radical or a hydrogen, metal or ammonium cation; and n represents an integer from 1 to 10;
wherein the weight ratio of said water retention agent(s) to said surfactant(s) is from 1:1 to 199:1.

2. The composition according to claim 1, wherein said water retention agent is selected from water soluble cellulose ethers, starch ethers, guar ethers, bacterial capsular polysaccharides, xanthan gum, dextran, welan gum, gellan gum, diutan gum, pullulan, and mixtures thereof.

3. The composition according to claim 2, wherein said water retention agent is a water-soluble cellulose ether.

4. The composition according to claim 1, further comprising one or more stabilizers selected from lime, air entraining agents, coalescents, superplasticizers, rheological modifiers and mixtures thereof.

5. The composition according to claim 1, wherein said surfactant is a dioctyl sulfosuccinate salt, a dihexyl sulfosuccinate salt or a combination thereof.

6. A process for producing a hydraulic binder-free composition for use as a modifying additive in a hydraulic setting mixture, said process comprising:
a. providing a liquid or solid composition comprising one or more water soluble polysaccharide-derived water retention agents;
b. providing a liquid composition comprising one or more surfactants according to Formula 1
MSO₃—R¹—(—COOR²)ₙ (Formula I)
wherein M represents a hydrogen, metal or ammonium cation; R¹ represents a linear or branched, saturated or unsaturated C₁₋₁₀ alkylene moiety which is optionally substituted with one or more hydroxyl, halogen, nitro and/or cyano groups; each R² independently represents a linear or branched, saturated or unsaturated C₁₋₂₂ alkyl radical or a hydrogen, metal or ammonium cation; and n represents an integer from 1 to 10;
c. preparing a water retention agent-surfactant mixture by combining an amount of the composition of step a) with an amount of the composition of step b) such that the weight ratio of said water retention agent(s) to said surfactant(s) is from 1:1 to 199:1; and
d. drying said water retention agent-surfactant mixture.

7. A modified dry mortar formulation which may be combined with water to form a hydraulic setting mixture, wherein said modified dry mortar comprises:
a. a standard dry mortar formulation comprising hydraulic binder; and
b. from 0.1 to 2.5%, based on the total dry weight of the modified hydraulic mortar formulation, of a composition according to claim 1,
wherein said modified dry mortar formulation comprises no more than 1%, based on the total dry weight of the modified dry mortar formulation, of surfactants according to Formula 1
MSO₃—R¹—(—COOR²)ₙ (Formula I)
wherein M represents a hydrogen, metal or ammonium cation; R¹ represents a linear or branched, saturated or unsaturated C₁₋₁₀ alkylene moiety which is optionally substituted with one or more hydroxyl, halogen, nitro and/or cyano groups; each R² independently represents a linear or branched, saturated or unsaturated C₁₋₂₂ alkyl radical or a hydrogen, metal or ammonium cation; and n represents an integer from 1 to 10.

8. The formulation of claim 7, which is a grout, cement-based tile adhesive (CBTA) or a cementitious adhesive or coating formulation for an Exterior Insulation Finishing System (EIFS) and/or an External Thermal Insulation Composite System (ETICS).

9. The formulation of claim 7, further comprising one or more redispersible polymer powders.

10. A hydraulic setting mixture comprising a dry mortar formulation according to claim 7 and water.

11. A method of modifying a dry mortar formulation, said method comprising:
a. providing a standard dry mortar formulation comprising hydraulic binder;
b. providing a composition according to claim 1; and
c. combining the composition of step b) with the formulation of step a) to provide a modified dry formulation comprising from 0.1 to 2.5%, based on the total dry weight of the modified hydraulic mortar formulation, of the composition of step b),
provided that the resultant modified dry mortar formulation comprises no more than 1%, based on the total dry weight of the modified dry mortar formulation, of surfactants according to Formula 1
MSO₃—R¹—(—COOR²)ₙ (Formula I)
wherein M represents a hydrogen, metal or ammonium cation; R¹ represents a linear or branched, saturated or unsaturated C₁₋₁₀ alkylene moiety which is optionally substituted with one or more hydroxyl, halogen, nitro and/or cyano groups; each R² represents independently represents a linear or branched, saturated or unsaturated C₁₋₂₂ alkyl radical or a hydrogen, metal or ammonium cation; and n represents an integer from 1 to 10.

12. Use of the composition according to claim 1 as a modifying additive for a hydraulic binder-containing dry mortar formulation or a hydraulic setting mixture comprising such a dry mortar formulation.

13. Use of a composition according to claim 1 for increasing, once cured, the adhesive, flexural and/or compressive strength of a dry mortar formulation comprising hydraulic binder.
